(19) United States
(12) Patent Application Publication
(10) Pub. No.: US 2021/0149676 A1
(43) Pub. Date: May 20, 2021

(54) Branch Prediction Method, Branch Prediction Unit and Processor Core

(71) Applicant: Higon Austin R&D Center Corporation, Austin, TX (US)

(72) Inventor: Lei CHEN, Austin, TX (US)

(21) Appl. No.: 16/683,527

(22) Filed: Nov. 14, 2019

(51) Int. Cl. G06F 9/38; G06F 9/30

(52) U.S. Cl. CPC G06F 9/3844; G06F 9/30058

(57) ABSTRACT

Disclosed are a branch prediction method, a branch prediction unit and a processor core. The branch prediction method comprises: obtaining a current branch address and a branch history corresponding to the current branch address; performing a first branch prediction on the current branch address to generate a first branch prediction result; generating a first branch prediction confidence according to the branch history and the first branch prediction result; and performing access control according to the first branch prediction confidence.

### TECHNICAL FIELD

Embodiments of the present disclosure relate to the field of processor technique, and more particularly to a branch prediction method, a branch prediction unit and a processor core.

### BACKGROUND

Modern processors typically adopt the pipeline technique to process instructions in parallel, so as to raise instruction processing efficiency. When processing branch instructions, most modern processors adopt the branch prediction technique to avoid a situation of waiting for execution results of branch instructions to determine a branch direction.

With the branch prediction technique, branch prediction results of the branch instructions, including the branch direction etc., can be predicted, thereby pushing the processors to perform a next instruction fetch operation, and avoiding a pipeline delay caused by waiting for execution results of the branch instructions. The branch prediction technique adopted by modern processors generally has multiple stages of branch prediction logic, when branch prediction is performed, the higher the stage number of the branch prediction logic accessed is, the higher the prediction accuracy of the branch prediction is, but at the same time, the higher the stage number of the branch prediction logic is, the greater the power consumption is, and the more clock cycles are required.

### SUMMARY

According to an aspect of the present disclosure, there is provided a branch prediction method, comprising: obtaining a current branch address and a branch history corresponding to the current branch address; performing a first branch prediction on the current branch address to generate a first branch prediction result; generating a first branch prediction confidence according to the branch history and the first branch prediction result; and performing access control according to the first branch prediction confidence.

According to some embodiments of the present disclosure, performing access control according to the first branch prediction confidence comprises determining whether the first branch prediction confidence meets a confidence condition based on a confidence threshold, wherein in the case where the first branch prediction confidence is greater than or equal to the confidence threshold, it is determined that the first branch prediction confidence meets the confidence condition; in the case where the first branch prediction confidence is less than the confidence threshold, it is determined that the first branch prediction confidence does not meet the confidence condition.

According to some embodiments of the present disclosure, the confidence threshold is determined according to a central value of a predetermined value range, or the confidence threshold is determined according to an upgrade degree of branch prediction performance.

According to some embodiments of the present disclosure, performing access control according to the first branch prediction confidence further comprises: in the case where the first branch prediction confidence meets the confidence condition, prohibiting a second branch prediction from being performed on the current branch address; and in the case where the first branch prediction confidence does not meet the confidence condition, performing a second branch prediction on the current branch address.

According to some embodiments of the present disclosure, performing access control according to the first branch prediction confidence further comprises: in the case where the first branch prediction confidence meets the confidence condition, prohibiting updating a branch record corresponding to the current branch address; and in the case where the first branch prediction confidence does not meet the confidence condition, updating a branch record corresponding to the current branch address.

According to some embodiments of the present disclosure, updating a branch record corresponding to the current branch address comprises: after executing a branch instruction corresponding to the current branch address, updating a branch record corresponding to the current branch address.

According to some embodiments of the present disclosure, the branch prediction method further comprises: after executing a branch instruction corresponding to the current branch address, recording an actual jump direction of the branch instruction corresponding to the current branch address.

According to some embodiments of the present disclosure, recording an actual jump direction of the branch instruction corresponding to the current branch address comprises: after executing the branch instruction corresponding to the current branch address, when the actual jump direction of the branch instruction indicates an instruction jump, adding a first value to a count value, and when the actual jump direction of the branch instruction indicates no instruction jump, subtracting a first value from the count value, wherein the count value represents the branch record, the value of the highest bit of the count value indicates a trusted branch prediction direction of the current branch address, and the value of the remaining bits of the count value indicates the branch history of the current branch address.

According to some embodiments of the present disclosure, performing a first branch prediction on the current branch address to generate a first branch prediction result comprises: determining the trusted branch prediction direction indicated by the value of the highest bit of the count value as a first branch prediction direction indicated by the first branch prediction result; generating a first branch prediction confidence according to the branch history and the first branch prediction result comprises: determining the first branch prediction confidence according to a matching degree between the branch history indicated by the value of the remaining bits of the count value and the first branch prediction direction.

According to some embodiments of the present disclosure, determining whether the first branch prediction confidence meets a confidence condition based on a confidence threshold further comprises: in the case where the number of times for which the first branch prediction confidence meets the confidence condition reaches a times threshold, directly determining the first branch prediction confidence as meeting the confidence condition, and comparing the first branch prediction confidence and the confidence threshold at intervals.

According to some embodiments of the present disclosure, the branch prediction method further comprises: determining to perform the first branch prediction or the second branch prediction according to a historical branch prediction confidence and a confidence allocation limit, wherein prediction accuracy of the second branch prediction is higher than that of the first branch prediction.

According to some embodiments of the present disclosure, in the case where the historical branch prediction confidence is greater than or equal to the confidence allocation limit, it is determined to perform the first branch prediction; and in the case where the historical branch prediction confidence is less than the confidence allocation limit, it is determined to perform the second branch prediction.

According to another aspect of the present disclosure, there is provided a branch prediction unit, comprising: a first branch prediction logic configured to obtain a current branch address and a branch history corresponding to the current branch address, perform a first branch prediction on the current branch address to generate a first branch prediction result, and generate a first branch prediction confidence according to the branch history and the first branch prediction result; an access control unit configured to perform access control according to the first branch prediction confidence; and a second branch prediction logic configured to perform a second branch prediction according to access control of the access control unit.

According to some embodiments of the present disclosure, the access control unit is further configured to determine whether the first branch prediction confidence meets a confidence condition based on a confidence threshold, which comprises: in the case where the first branch prediction confidence is greater than or equal to the confidence threshold, determining that the first branch prediction confidence meets the confidence condition; in the case where the first branch prediction confidence is less than the confidence threshold, determining that the first branch prediction confidence does not meet the confidence condition, wherein the confidence threshold is determined according to a central value of a predetermined value range, or the confidence threshold is determined according to an upgrade degree of branch prediction performance.

According to some embodiments of the present disclosure, in the case where the first branch prediction confidence meets the confidence condition, the access control unit prohibits a second branch prediction from being performed by the second branch prediction logic on the current branch address; and in the case where the first branch prediction confidence does not meet the confidence condition, the access control unit controls the second branch prediction logic to perform a second branch prediction on the current branch address.

According to some embodiments of the present disclosure, in the case where the first branch prediction confidence meets the confidence condition, the access control unit prohibits the second branch prediction logic from updating a branch record corresponding to the current branch address; and in the case where the first branch prediction confidence does not meet the confidence condition, the second branch prediction logic controls the second branch prediction logic to update a branch record corresponding to the current branch address.

According to some embodiments of the present disclosure, the branch prediction unit further comprises: a counter configured to, after executing a branch instruction corresponding to the current branch address, record an actual jump direction of the branch instruction corresponding to the current branch address, wherein in the case where the actual jump direction of the branch instruction indicates an instruction jump, the counter adds a first value to a count value, and in the case where the actual jump direction of the branch instruction indicates no instruction jump, the counter subtracts a first value from the count value, wherein the count value represents the branch record, the value of the highest bit of the count value indicates a trusted branch prediction direction of the current branch address, and the value of the remaining bits of the count value indicates the branch history of the current branch address.

According to some embodiments of the present disclosure, the first branch prediction unit determines the trusted branch prediction direction indicated by the value of the highest bit of the count value as a first branch prediction direction indicated by the first branch prediction result; and the first branch prediction unit determines the first branch prediction confidence according to a matching degree between the branch history indicated by the value of the remaining bits of the count value and the first branch prediction direction.

According to some embodiments of the present disclosure, the access control unit is further configured to: determine to perform the first branch prediction or the second branch prediction according to a historical branch prediction confidence and a confidence allocation limit, wherein in the case where the historical branch prediction confidence is greater than or equal to the confidence allocation limit, the access control unit determines to perform the first branch prediction by the first branch prediction logic; and in the case where the historical branch prediction confidence is less than the confidence allocation limit, the access control unit determines to perform the second branch prediction by the second branch prediction logic, wherein prediction accuracy of the second branch prediction is higher than that of the first branch prediction logic.

According to another aspect of the present disclosure, there is provided a processor core, comprising the branch prediction unit as described above.

### BRIEF DESCRIPTION OF THE DRAWINGS

In order to more clearly illustrate the technical solutions in the embodiments of the present application or in the prior art, drawings necessary for describing the embodiments or the prior art will be briefly introduced below, obviously, the following described drawings are merely embodiments of the present disclosure, for those of ordinary skill in the art, it is possible to attain other drawings based on these drawings without paying creative effort.

FIG. 1 is a schematic diagram of a computer system architecture;

FIG. 2 is a schematic diagram of a processor core implementing the 5-stage pipeline technique;

FIG. 3 is a schematic diagram of a branch prediction unit having two stages of branch prediction logic;

FIG. 4 is a flowchart of a branch prediction method according to some embodiments of the present disclosure;

FIG. 5 is a schematic diagram of the count value according to some embodiments of the present disclosure;

FIG. 6 is a schematic diagram of a branch prediction unit according to some embodiments of the present disclosure;

FIG. 7 is a schematic diagram of an implementation according to some embodiments of the present disclosure;

FIG. 8 is a schematic diagram of another implementation according to some embodiments of the present disclosure; and

FIG. 9 is a schematic block diagram of a branch prediction unit according to some embodiments of the present disclosure.

### DETAILED DESCRIPTION OF THE EMBODIMENTS

Hereinafter, the technical solutions in the embodiments of the present disclosure will be described clearly and comprehensively in combination with the drawings, obviously, these described embodiments are only parts of the embodiments of the present disclosure, rather than all of the embodiments thereof, all the other embodiments obtained by those of ordinary skill in the art based on the embodiments of the present disclosure without paying creative efforts fall into the protection scope of the present disclosure.

Words and expressions such as “first”, “second” and the like used in the present disclosure do not denote any sequence, quantity or priority, but are used to distinguish different components. Words such as “include”, “comprise” and the like refer to that an element or an object before these words contains all the elements or objects listed thereinafter or alternatives thereof, without excluding other elements or objects. Words such as “connected”, “connecting” and the like are not restricted to physical or mechanical connections, but may include electrical connections, regardless of direct or indirect connections.

Flowcharts are used in the present disclosure to illustrate steps of the method according to the embodiment of the present disclosure. It should be understood that the preceding or subsequent steps are not necessarily performed in the precise order. Instead, the respective steps may be processed in the reverse order or simultaneously. Also, other operations may be added to these procedures, one or more steps may be removed from these procedures.

As described above, in the branch prediction technique, the conventional performance-centric method largely focuses only on increasing the number of stages of branch prediction logic so as to increase the accuracy of branch prediction, thereby obtaining higher branch prediction performance. However, an increase in the number of stages of branch prediction logic also means an increase in the power consumption and an increase in the number of operating clock cycles, the branch prediction technique and the branch prediction logic that implements branch prediction will be described in detail below in conjunction with FIG. 1.

As an alternative example of the contents disclosed in the embodiment of the present disclosure, FIG. 1 is a schematic diagram of a computer system architecture. It should be noted that the schematic diagram is shown to facilitate understanding the contents disclosed in the embodiment of the present disclosure, and the embodiment of the present disclosure is not limited to the architecture shown in FIG. 1.

Referring to FIG. 1, the computer system 1 may include a processor 11, a memory 12 coupled to the processor 11, and a Southbridge 13 coupled to the processor 11.

The processor 11 may include a Complex Instruction Set Computer (CISC) microprocessor, a Reduced Instruction Set Computer (RISC) microprocessor, a Very Long Instruction Word (VLIW) microprocessor, a processor that implements a combination of instruction sets, or any other processor device such as a digital signal processor.

As shown in FIG. 1, the processor 11 may be integrated with at least one processor core 100 for executing at least one instruction. The processor core 100 represents a processor core having any type of architecture, such as a RISC processor core, a CISC processor core, a VLIM processor core, or a hybrid processor core, etc., the processor core 100 may be implemented in any suitable manner. In the case where the processor 11 is integrated with multiple processor cores 100, the processor cores may be isomorphic or heterogeneous in terms of architecture and/or instruction set. In an alternative implementation, some processor cores 100 may be in order, while other processor cores 100 may be out of order. In another alternative implementation, two or more processor cores 100 may execute the same instruction set, while other processor cores 100 may execute subsets of the same instruction set or may execute different instruction sets.

A memory controller or the like (not shown) may be integrated in the processor 11, and a memory interface or the like (not shown) may be externally provided. The processor 11 may be coupled to the memory 12 via the memory interface. At the same time, the processor 11 may be coupled to a processor bus and coupled to the Southbridge 13 via the processor bus.

The Southbridge 13 may be integrated with a bus interface 14 that communicates with other components of the computer system, so that signal transmission between the processor 11 and most other components of the computer system 1 is implemented through the Southbridge 13. It should be noted that in the present disclosure, the components of the computer system 1 may be added and adjusted according to actual conditions, which will not be detailed one by one herein.

For example, the bus interface 14 integrated with the Southbridge 13 includes, but not limited to, a memory (such as a hard disk) bus interface, a USB bus interface, a network controller bus interface, a PCIE bus interface, and the like.

It should be noted that the coupling structure of the processor 11 and the Southbridge 13 in the example block diagram of FIG. 1 is basic, but the specific refinement structure of the processor 11 and the Southbridge 13 is not fixed, but may be set, adjusted, and/or expanded according to specific use conditions.

According to other embodiments of the present disclosure, for example, in other computer system architectures, such as computer system architectures in which Southbridge and Northbridge are installed, memory control may also be provided by the Northbridge, for example, the Northbridge is coupled between the processor and the Southbridge, it is mainly responsible for signal transmission between the graphics card, the memory and the processor; the Southbridge is mainly responsible for signal transmission between the hard disk, peripherals, various input/output (I/O) interfaces with low bandwidth requirements and the memory, the processor.

The processor and the Southbridge-type computer architecture are described above. In other examples of the computer architecture, it is also possible to implement the computer architecture by System on Chip (SoC). Exemplarily, the SoC may integrate a processor, a memory controller, and an I/O interface etc., and the SoC can build a computer architecture on a single main chip by coupling with other components such as external memories, I/O devices, and network cards.

It should be further noted that the above described structure is not limited to the computer system, but may also be used in for example handheld devices and other devices having embedded applications. Examples of handheld devices include a cellular phone, an Internet Protocol device, a digital camera, a personal digital assistant (PDA), or a personal computer. Other devices having embedded applications may include a Net PC, a set top box, a server, a wide area network (WAN) switch, or any other system that can execute one or more instructions of at least one embodiment of the present disclosure.

In addition, the processor described above is not limited to a Central Processing Unit (CPU), but may also be an accelerator (e.g., a graphics accelerator or a digital signal processing unit), a Graphics Processing Unit (GPU), a field programmable gate array or any other processor with an instruction execution function. Although a single processor is illustrated in the above, in practice, the computer architecture may have multiple processors each of which has at least one processor core.

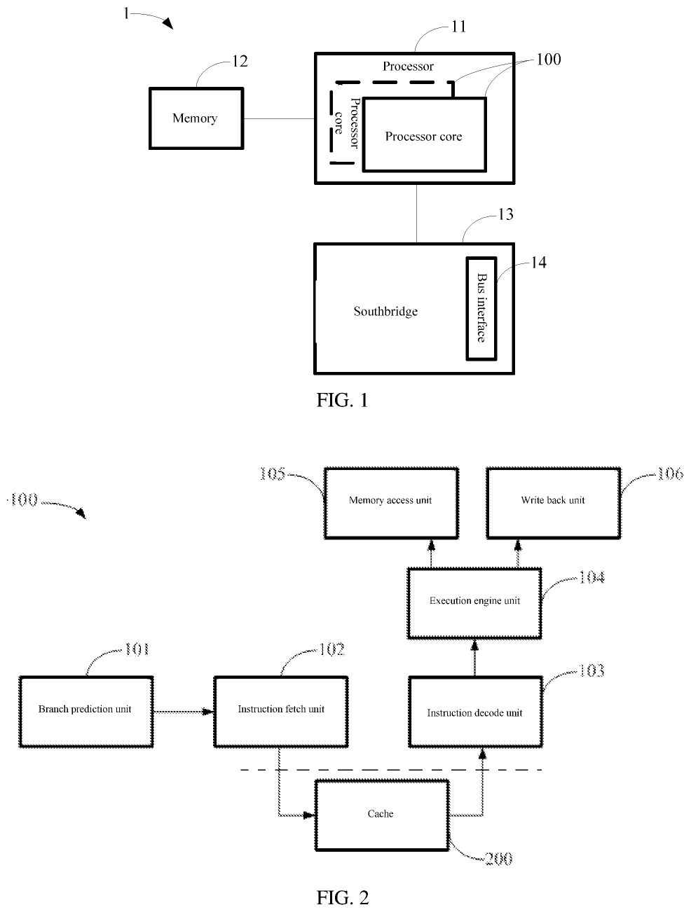

Modern microprocessor architectures generally use the pipeline technique to implement parallel processing of multiple instructions, and combine branch prediction, out of order execution, and other techniques to improve pipeline execution efficiency. As an alternative example of the contents disclosed in the embodiment of the present disclosure, FIG. 2 exemplarily shows a schematic diagram of a processor core implementing a 5-stage pipeline technique. For example, processing of the 5-stage pipeline may include Instruction Fetch, Instruction Decode, Execute, Memory Access and Write Back.

Referring to FIG. 2, the processor core 100 implementing the 5-stage pipeline technique may include a branch prediction unit 101, an instruction fetch unit 102, an instruction decode unit 103, an execution engine unit 104, a memory access unit 105, a write back unit 106 and a cache 200. It should be noted that the schematic diagram is shown to facilitate understanding of the contents disclosed in the embodiment of the present disclosure, and the embodiment of the present disclosure is not limited to the architecture shown in FIG. 2.

In order to solve the pipeline delay caused by that the processor core waits for the execution result of the branch instruction to determine a next instruction fetch operation when processing the branch instruction, a branch prediction unit (e.g., the branch prediction unit 101 as shown in FIG. 2) may be set before the pipeline operation so as to implement branch prediction before actually executing the branch instruction, so that the instruction fetch unit 102 performs an instruction fetch operation in advance, thereby avoiding the pipeline delay caused by waiting to know the execution result of the branch instruction.

As shown in FIG. 2, an instruction received by the instruction fetch unit 102 may be represented as a branch instruction, which may be an execution result after processing operations by other execution units. Alternatively, as shown in FIG. 2, direction prediction may be performed on the branch instruction by the branch prediction unit 101, for example, the branch prediction unit 101 may predict a branch direction of the branch instruction, so that there is no need to wait for the actual execution result of the branch instruction, the instruction fetch unit 102 performs an instruction fetch operation according to the predicted branch direction.

For example, the actual execution result of the branch instruction is generally divided into two cases: the branch instruction does not jump, and the next instruction is the next sequential branch instruction which having the instruction address following the branch instruction. That is, the instruction to be fetched by the instruction fetch unit 102 is the next instruction of the branch instruction. Or, the branch instruction jumps, the next instruction is the instruction to jump to, that is, the instruction to be fetched by the instruction fetch unit 102 is the instruction to jump to, not the next sequential branch instruction.

The branch prediction unit 101, the instruction fetch unit 102, the instruction decode unit 103, the execution engine unit 104, the memory access unit 105 and the write back unit 106 may be logic circuit units integrated in the processor core.

Alternatively, all or part of the cache 200 may be integrated into the processor core. As an example, the cache 200 may include at least one internal cache integrated into the processor core, at least one external cache resident outside the processor core. Of course, the embodiment of the present disclosure also supports integrating all the cache 200 into the processor core 100, in some cases, the embodiment of the present disclosure may also support that the cache 200 all resides outside the processor core 100. It should be noted that, regardless of how levels of the cache integrated in the processor core and residing outside the processor core are set, in general, the cache 200 may include a multi-level cache, for example, including a first-level cache and a second-level cache. For the cache 200, the previous-level cache caches information from the next-level cache, for example, the first-level cache can cache information from the second-level cache, which is of course an optional manner.

The branch prediction unit 101 may perform branch prediction to obtain a branch prediction result of a branch instruction, and the branch prediction result of the branch instruction may be, for example, a branch direction, an address, a target address, and the like of the branch instruction. In an implementation, branch prediction may be performed based on a branch record of the branch instruction.

For example, the branch record used by a branch prediction logic as the basis for performing branch prediction may include historical execution information of the branch instruction and a historical branch result. For example, with the branch prediction logic uses the Branch Target Buffer (BTB) technique as an example, the branch record may record a historical target address of the branch instruction, etc., and with the branch prediction logic uses the Branch History Table (BHT) technique as an example, the branch record may record whether the branch direction of the branch instruction jumps or not (whether it is taken or not).

According to the embodiment of the present disclosure, based on the branch prediction result of the branch prediction unit 101, the instruction fetch unit 102 may read an instruction (including, but not limited to, a reading branch instruction, a logic operation instruction, a memory access instruction, etc.) through the cache 200, and will feed the fetched instruction to the instruction decode unit 103. In an optional implementation, the instruction fetch unit 102 may store the read instruction into an instruction register of the processor core 100, so that the instruction decode unit 103 reads the instruction from the instruction register for decoding. The instruction register is a register for temporarily placing the program instruction obtained from the memory.

The instruction decode unit 103 may interpret the instruction to obtain a decoding result. The decoding result may be machine-executable operation information obtained from interpreting the instruction, such as machine-executable micro-instruction (uop) formed by interpreting the opcode, the operand, and the control field of the instruction. Alternatively, the instruction decode unit 103 may read the source operand from a register file (also known as a register bank) and parse the opcode to generate a control signal.

The execution engine unit 104 may perform an operation based on the decoding result of the instruction decode unit 103 to generate an execution result (wherein the execution result corresponds to an instruction function of the fetch instruction, involving memory access, logical operation result, instruction jump, etc.). Alternatively, the execution engine unit 104 may support the out-of-order execution technique.

The memory access unit 105 may perform a memory access operation based on the execution result of the memory access instruction by the execution engine unit 104. The write back unit 106 may write the execution result back to the register file based on the execution result of the logic execution instruction by the execution engine unit 104.

It should be noted that FIG. 2 exemplarily shows a schematic diagram of a processor core 100 having a 5-stage pipeline architecture, and with technique adaptation, the logic circuit units at different stages in the pipeline may be integrated or separated, and the architecture thereof is not fixed. Meanwhile, the processor core in the embodiment of the present disclosure may also be applied to other pipeline techniques such as a 4-stage pipeline.

It is to be understood that the processor core 100 may also include other circuits (not shown) that are not necessary to understand the contents disclosed in the embodiment of the present disclosure, and since the other circuits are not essential to understanding of the contents disclosed in the embodiment of the present disclosure, no more details will be repeated in the embodiment of the present disclosure.

When designing a branch prediction unit, it is often desirable for the branch prediction unit to predict the possible branch direction of the branch instruction at a faster speed. However, predicting the possible branch direction at a faster speed means that the number of stages of the branch prediction logic is less, for example, branch prediction is performed using only one stage of branch prediction logic. In this case, although the number of clock cycles used for branch prediction may be reduced, the result is often a decrease in prediction accuracy of branch prediction.

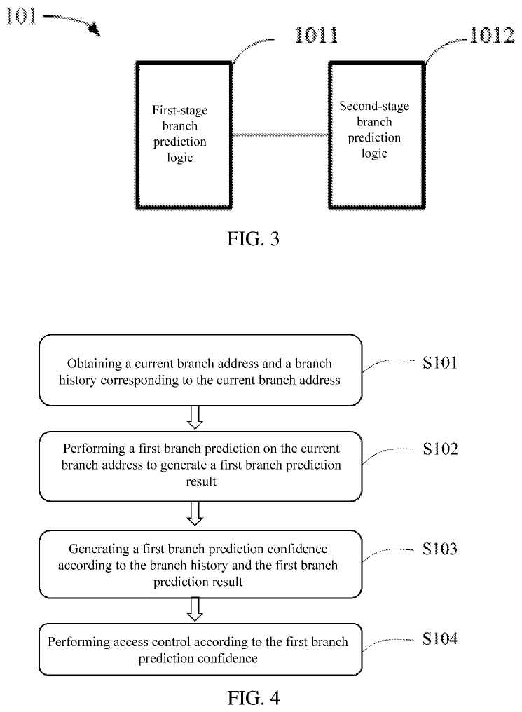

The branch prediction unit in modern processors typically employs multiple stages of branch prediction logic, by way of example, FIG. 3 shows a schematic diagram of a branch prediction unit with two stages of branch prediction logic. Referring to FIG. 3, the branch prediction unit 101 may have, for example, a first-stage branch prediction logic 1011 and a second-stage branch prediction logic 1012, wherein prediction accuracy of the first-stage branch prediction logic 1011 is lower than that of the second-stage branch prediction logic 1012.

Before starting the pipeline processing, the branch prediction unit 101 may perform branch prediction on the current branch address to obtain a branch prediction result. For example, when performing branch prediction, input of the branch prediction logic may be the current branch address and the branch history corresponding to the current branch address. Exemplarily, when the BTB technique is used, the current branch address may be, for example, a start address of a next fetch operation from the last output of the branch prediction unit, and the like. In other words, the branch history corresponding to the current branch address may indicate the historical branch direction of the current branch address. At this time, the branch history corresponding to the current branch address may be partial information of the branch record corresponding to the current branch address, for example, the branch history corresponding to the current branch address may include information such as the historical branch direction corresponding to the current branch address.

Although the first-stage branch prediction logic 1011 is lower than the second-stage branch prediction logic 1012 in prediction accuracy, the first-stage branch prediction logic 1011 acquires the branch prediction result faster than the second-stage branch prediction logic 1012, so the instruction fetch unit 102 in the pipeline may first access the first-stage branch prediction logic 1011, and branch prediction is performed on the current branch address by the first-stage branch prediction logic 1011, so that the instruction fetch unit 102 may read the instruction according to the first branch prediction result of the first-stage branch prediction logic 1011 (the instruction read at this time may be correct or incorrect). As described above, the branch prediction result may be, for example, a branch prediction direction, an address, a target address, and the like of the branch instruction corresponding to the current branch address.

The second-stage branch prediction logic 1012 has higher prediction accuracy than the first-stage branch prediction logic 1011, but requires more clock cycles and brings more power consumption. After the first-stage branch prediction logic 1011 has completed branch prediction, an access may be made to the second-stage branch prediction logic 1012. That is, the second-stage branch prediction logic 1012 may perform the second branch prediction on the current branch address after the first branch prediction logic 1011 completes the first branch prediction, thereby obtaining the second branch prediction result. According to the embodiment of the present disclosure, whether to correct the instruction fetch operation based on the first branch prediction result may be determined based on the second branch prediction logic having higher accuracy, that is, deciding whether the instruction fetch unit 102 is to re-perform an instruction fetch operation, for example, instruction re-fetching is performed according to the second branch prediction direction indicated by the second branch prediction result.

For example, if the branch prediction results of the second-stage branch prediction logic 1012 and the first-stage branch prediction logic 1011 are inconsistent, instruction re-fetching is performed, and if the branch prediction results of the second-stage branch prediction logic 1012 and the first-stage branch prediction logic 1011 are consistent, there is no need to re-fetch, it may continue to execute the instruction read according to the first branch prediction result of the first-stage branch prediction logic 1011.

Of course, after the first branch prediction logic 1011 completes the first branch prediction, accessing the second-stage branch prediction logic 1012 is only an optional implementation. Depending on the different design, access orders of the first-stage branch prediction logic 1011 and the second-stage branch prediction logic 1012 may be different. For example, access to the second-stage branch prediction logic 1012 may take a longer time, so access to the second-stage branch prediction logic 1012 may start earlier. For another example, in the case where access to the second-stage branch prediction logic 1012 is not necessary, access to the second-stage branch prediction logic 1012 may be suspended beforehand, i.e., the instruction fetch unit 102 does not access the second-stage branch prediction logic. In other words, in some cases, the second-stage branch prediction logic 1012 may be disabled from performing the second branch prediction.

It should be noted that the above example is only described by the branch prediction unit adopts two stages of branch prediction logic as an example, the number of stages of the branch prediction logic adopted by the branch prediction unit may be determined according to actual conditions, and no limitations is made herein.

As can be seen, in the case of performing branch prediction, when the stage number of the branch prediction logic is higher, although the prediction accuracy may be higher, the power consumption of branch prediction will also increase, and the branch prediction logic at the relatively high stage and the branch prediction logic at the relatively low stage may have consistent branch prediction results for the same branch instruction. In other words, in some cases, access to the higher-stage branch prediction logic is not necessary, for example, the first branch prediction result of the first-stage branch prediction logic and the second branch prediction result of the second-stage branch prediction logic are the same. At this time, the access to the second-stage branch prediction logic may be suspended beforehand to avoid power consumption caused by accessing the second-stage branch prediction logic, meanwhile accuracy of the branch prediction result is also ensured.

As described above, it is desirable to provide a branch prediction method to balance prediction accuracy and power consumption of branch prediction when using multiple stages of branch prediction logic, that is, to reduce prediction power consumption as much as possible while ensuring the prediction accuracy of branch prediction. When using multiple stages of branch prediction logic, balancing prediction accuracy and power consumption of the branch prediction may serve as an optional implementation of the contents disclosed in the embodiment of the present disclosure.

FIG. 4 is a flowchart of a branch prediction method according to some embodiments of the present disclosure. First, in step S101, a current branch address and a branch history corresponding to the current branch address is obtained. The current branch address may correspond to a branch instruction, and the branch history may, for example, represent a historical branch direction of the branch instruction, exemplarily, latest predetermined number of times of the historical branch direction corresponding to the current branch address (e.g., the branch direction may be divided into two: branch instruction jumps and branch instruction does not jump), etc., the predetermined number of times may be set according to actual conditions, no limitation is made in the embodiment of the present disclosure.

Next, in step S102, a first branch prediction is performed on the current branch address to generate a first branch prediction result. According to the embodiment of the present disclosure, the first branch prediction may be performed by a lower-stage branch prediction logic, and the first branch prediction result may include a branch prediction direction generated for the branch instruction by the lower-stage branch prediction logic, or may also include information such as a target address, for the instruction fetch unit to perform an instruction fetch operation.

Next, in step S103, a first branch prediction confidence is generated according to the branch history and the first branch prediction result. For example, any branch prediction logic that performs branch prediction may perform branch prediction on the current branch address, output a branch prediction result corresponding to the current branch address, and output a corresponding branch prediction confidence according to the branch prediction result outputted and the branch history corresponding to the current branch address, the branch prediction confidence may indicate prediction accuracy of the branch prediction result outputted by the branch prediction logic for the current branch address. According to the embodiment of the present disclosure, the first branch prediction confidence may be generated according to a matching degree between the historical branch direction indicated by the branch history and the first branch prediction direction in the first branch prediction result.

Finally, access control is performed based on the first branch prediction confidence in step S104. The access control may include branch prediction control and branch record update control, and the branch prediction control may be represented as controlling whether to perform a second branch prediction having higher prediction accuracy than the first branch prediction, the branch record update control may be represented as controlling whether to update the branch record which serves as the execution basis of the higher-stage second branch prediction.

For example, performing access control according to the first branch prediction confidence may comprise determining whether the first branch prediction confidence meets a confidence condition based on a confidence threshold.

As an optional implementation of the contents disclosed in the embodiment of the present disclosure, taking the first branch prediction confidence as an example, the confidence threshold may be set to determine whether the first branch prediction confidence meets a confidence condition. For example, in the case where the first branch prediction confidence is greater than or equal to the confidence threshold, it is determined that the first branch prediction confidence meets the confidence condition, that is, the first branch prediction confidence is trusted; in the case where the first branch prediction confidence is less than the confidence threshold, it is determined that the first branch prediction confidence does not meet the confidence condition, that is, the first branch prediction confidence is untrusted.

Optionally, the confidence threshold may be a static value or a dynamic value.

For example, in the case where the confidence threshold is a static value, the confidence threshold may be determined according to a central value of a predetermined value range. Herein, the static value may be regarded as a midpoint of a simple numerical range, for example, a predetermined numerical range may be set, and a central value of the predetermined numerical range is used as the confidence threshold. Taking a single-bit number as an example, 1 may indicate a high confidence (i.e., the branch prediction confidence reaches the confidence threshold), and 0 may indicate a low confidence (i.e., the branch prediction confidence is below the confidence threshold). In the case of multiple bits, for example, three bits (such as a 3-bit saturation counter), when only the first bit is 1, it indicates a low confidence (i.e., the branch prediction confidence is lower than the confidence threshold), when the second bit and the third bit are 1, it indicates a high confidence (i.e., the branch prediction confidence is higher than the confidence threshold).

For example, in the case where the confidence threshold is a dynamic value, the embodiment of the present disclosure may establish a dynamic confidence threshold table through the branch record of the current branch address, the confidence threshold table may be a counter table implemented by a single-bit counter or a multi-bit counter, or a counter table indexed by the historical record of the branch address, or a combination of the two. Optionally, adjustment of the dynamic confidence threshold may be determined based on whether the high-stage branch prediction logic contributes to upgrade of branch prediction performance.

It may be understood that the higher the confidence threshold is, the more likely the branch prediction confidence of the low-stage branch prediction logic is determined to be not meet the confidence condition, and accordingly, the greater the possibility of accessing the high-stage branch prediction logic is, so when the high-stage branch prediction logic helps improve branch prediction performance, for example, correcting the prediction result of low-stage branch prediction, the confidence threshold may be increased accordingly. Conversely, if the high-stage branch prediction logic does not contribute to upgrade of branch prediction performance, the confidence threshold may be lowered. It can be seen that, taking the first branch prediction logic and the second branch prediction logic described above as an example, the value of the confidence threshold has a positive correlation with upgrade of branch prediction performance by the second branch prediction logic. In other words, in an implementation according to the present disclosure, the confidence threshold may be determined based on the upgrade degree of branch prediction performance.

Optionally, the embodiment of the present disclosure may be, after comprehensively considering prediction accuracy and power consumption of the branch prediction, determining access to the branch prediction logic with a relatively long delay or a relatively short delay according to the upgrade of the performance of the branch prediction, and the specific manner for determining upgrade of the branch prediction performance is not limited in the implementation of the present disclosure.

According to the embodiment of the present disclosure, performing access control according to the first branch prediction confidence may further comprise: in the case where the first branch prediction confidence meets the confidence condition, prohibiting a second branch prediction from being performed on the current branch address, that is, performing branch prediction control.

The first branch prediction confidence meets the confidence condition means that the first branch prediction result has a relatively high branch prediction accuracy, that is, the second branch prediction result generated by the higher-stage second branch prediction is likely to be consistent with the first branch prediction result. At this time, it is considered that the instruction fetch operation according to the first branch prediction result may be continuously performed without performing the higher-stage second branch prediction, thereby reducing the power consumption caused by performing the second branch prediction, and correspondingly reducing the operating clock cycle number.

In the case where the first branch prediction confidence does not meet the confidence condition, the second branch prediction on the current branch address may be performed. That is, in the case where prediction accuracy of the first branch prediction result is lower, it is necessary to further perform the second branch prediction on the current branch address by the higher-stage second branch prediction logic, thereby determining whether to correct the instruction fetch according to the second prediction result outputted by the second branch prediction logic.

According to the embodiment of the present disclosure, performing access control according to the first branch prediction confidence may further comprise: in the case where the first branch prediction confidence meets the confidence condition, prohibiting updating a branch record corresponding to the current branch address. In the case where the first branch prediction confidence does not meet the confidence condition, the branch record corresponding to the current branch address is updated.

For example, if the first branch prediction confidence meets the confidence condition, it indicates that prediction accuracy of the first branch prediction result generated by performing the first branch prediction is relatively high, and the branch record for performing the second branch prediction may be prohibited from being updated. It may be understood that the higher prediction accuracy of the first branch prediction result indicates that the first branch prediction performed on the current branch address already has relatively high prediction accuracy, and the branch record for performing the first branch prediction may be updated, while the branch record for performing the second branch prediction does not have to be updated, thereby power consumption of the branch prediction is reduced. If the first branch prediction confidence does not meet the confidence condition, then prediction accuracy of the first branch prediction result is relatively low, the branch record for performing the second branch prediction may be updated. Furthermore, in the case the first branch prediction confidence meets the confidence condition, the updating process may further relate to the second branch prediction.

According to the embodiment of the present disclosure, updating a branch record corresponding to the current branch address may comprise: after executing a branch instruction corresponding to the current branch address, updating a branch record corresponding to the current branch address.

It should be noted that execution of the branch instruction may be implemented by an execution unit of the processor core, and after executing the branch instruction, an actual jump direction of the branch instruction may be determined, thereby the branch record of the branch instruction may be updated according to the actual jump direction of the branch instruction.

In other words, before the branch instruction corresponding to the current branch address is actually executed by the processor core, the branch prediction direction of the branch instruction may be generated by the branch prediction unit, that is, the possible branch direction of the branch instruction is predicted, then the instruction fetch unit performs an instruction fetch operation according to the branch prediction direction. After the branch instruction is actually executed, the actual branch direction of the branch instruction can be known, for example, whether the instruction jumps, at this time, the branch record of the branch instruction may be updated by using the actual branch direction of the branch instruction.

The branch prediction method according to the embodiment of the present disclosure further comprises, after executing a branch instruction corresponding to the current branch address, recording an actual jump direction of the branch instruction corresponding to the current branch address.

According to the embodiment of the present disclosure, the actual jump direction of the branch instruction corresponding to the current branch address may be implemented by using a count value. For example, after executing the branch instruction corresponding to the current branch address, when the actual jump direction of the branch instruction indicates an instruction jump, a first value is added to the count value, and when the actual jump direction of the branch instruction indicates no instruction jump, a first value is subtracted from the count value. The count value represents the branch record, the value of the highest bit of the count value indicates a trusted branch prediction direction of the current branch address, and the value of the remaining bits of the count value indicates the branch history of the current branch address. In addition, the value of the remaining bits may also indicate a confidence degree of the current branch address in the trusted branch prediction direction of the confidence.

The count value may have three-bit or two-bit, and the number of the bits of the count value may be selected according to actual conditions.

Optionally, when counting with respect to the counter, the first value may be a number 1. For the current branch address, after each execution of the branch instruction corresponding to the current branch address, if the actual jump direction indicates an instruction jump, then the count value is incremented by one until reaching the limit of the number of the counter bits if the actual jump direction indicates that the instruction does not jump, the count value is decremented by one.

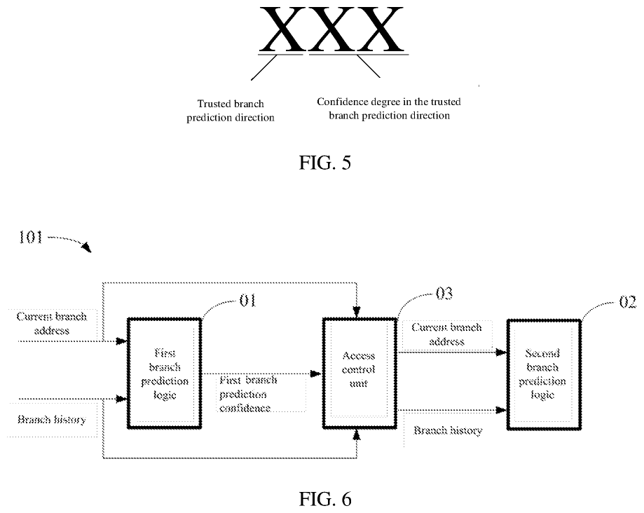

FIG. 5 is a schematic diagram of the count value according to some embodiments of the present disclosure, wherein the count value has three bits of data. For example, when the count value of the current branch address is 111, the value of the highest bit of the count value is 1, and the trusted branch prediction direction of the current branch address may be expressed as an instruction jump, the value of the remaining bits except the highest bit is 11, which indicates that the current branch address has a very high degree of confidence in the prediction direction of instruction jump.

According to the embodiment of the present disclosure, performing a first branch prediction on the current branch address to generate a first branch prediction result may comprise: determining the trusted branch prediction direction indicated by the value of the highest bit of the count value as a first branch prediction direction indicated by the first branch prediction result. At this time, the count value may be understood as the branch record and serves as the execution basis of branch prediction. In other words, when performing branch prediction, the trusted branch prediction direction indicated by the highest bit value of the count value may be determined as the first branch prediction direction included in the first branch prediction result.

Thereafter, the first branch prediction confidence may be generated according to the branch history and the first branch prediction result. The first branch prediction confidence may be determined according to a matching degree between the branch history indicated by the value of the remaining bits of the count value and the first branch prediction direction.

Here, the count value being 111 is taken as an example for description. The first branch prediction may use the trusted branch prediction direction indicated by the value of the highest bit as the first branch prediction direction, and make an output, that is, the prediction result of the first branch prediction is an instruction jump. The branch history may be represented by the value of the remaining bits of the count value, that is, 11. The count value 111 means that the actual execution result of the branch instruction corresponding to the current branch address is instruction jump for at least 7 times, then the matching degree between the branch history and the first branch prediction direction may be considered to be higher, and the first branch prediction confidence may be determined according to the matching degree, and the foregoing determination of the first branch prediction confidence may also adopt other manners, which is not limited herein.

According to the embodiment of the present disclosure, determining whether the first branch prediction confidence meets a confidence condition based on a confidence threshold further comprises: in the case where the number of times for which the first branch prediction confidence meets the confidence condition reaches a times threshold, directly determining the first branch prediction confidence as meeting the confidence condition, and comparing the first branch prediction confidence and the confidence threshold at intervals.

In the case where the number of times for which the first branch prediction confidence meets the confidence condition reaches the times threshold, the first branch prediction may be considered to have a relatively high branch prediction accuracy for the current branch address, at this time, a predetermined number of intervals may be spaced. For example, it is judged once every three times whether the branch prediction confidence for the current branch address outputted by the first branch prediction meets the confidence condition, and in other cases, the first branch prediction confidence of the first branch prediction result is considered in default as satisfying the confidence condition. Herein, if it is determined for once that the first branch prediction confidence does not meet the confidence condition, the subsequent determination may determine whether the first branch prediction confidence meets the confidence condition at every time until the consecutive number of times for which the first branch prediction confidence meets the confidence condition reaches the times threshold again.

The branch prediction method according to the present disclosure may further comprise: determining to perform the first branch prediction or the second branch prediction according to a historical branch prediction confidence and a confidence allocation limit, wherein prediction accuracy of the second branch prediction is higher than that of the first branch prediction. For example, in the case where the historical branch prediction confidence is greater than or equal to the confidence allocation limit, it is determined to perform the first branch prediction; and in the case where the historical branch prediction confidence is less than the confidence allocation limit, it is determined to perform the second branch prediction.

In an optional implementation, the branch record may further include a historical branch prediction confidence for the current branch address. The branch history of the current branch address may include branch direction of the latest number of times of the current branch address. A confidence allocation limit may be set, if the historical branch prediction confidence is lower than the set confidence allocation limit, prediction accuracy of branch prediction for the current branch address by the first branch prediction is considered to be relatively low, instead of using the first branch prediction logic to perform branch prediction on the current branch, it is determined to perform a second branch prediction on the current branch address. If the historical branch prediction confidence is not lower than the set confidence allocation limit, the first branch prediction is considered to have relatively high prediction accuracy for the branch prediction of the current branch address, and the first branch prediction may be determined to be performed on the current branch address.

For example, the historical branch prediction confidence for the current branch address may be an average of the branch prediction confidences of the historical first branch prediction results.

As described above, the branch prediction method according to the present disclosure can achieve a balance between prediction accuracy and power consumption of branch prediction when using multi-stage branch prediction, that is, power consumption of branch prediction is reduced as much as possible while prediction accuracy of branch prediction is ensured.

The present disclosure also provides a branch prediction unit, FIG. 6 shows a schematic diagram of the branch prediction unit.

Referring to FIG. 6, the branch prediction unit 101 may include a first branch prediction logic 01, a second branch prediction logic 02 and an access control unit 03.

According to the embodiment of the present disclosure, the first branch prediction logic 01 may be configured to obtain a current branch address and a branch history corresponding to the current branch address, perform a first branch prediction on the current branch address to generate a first branch prediction result, and generate a first branch prediction confidence according to the branch history and the first branch prediction result. The access control unit 03 may be configured to perform access control according to the first branch prediction confidence. The second branch prediction logic 02 may be configured to perform a second branch prediction according to access control of the access control unit.

According to the embodiment of the present disclosure, the access control unit 03 may be further configured to determine whether the first branch prediction confidence meets a confidence condition based on a confidence threshold, which comprises: in the case where the first branch prediction confidence is greater than or equal to the confidence threshold, determining that the first branch prediction confidence meets the confidence condition; in the case where the first branch prediction confidence is less than the confidence threshold, determining that the first branch prediction confidence does not meet the confidence condition. For example, the confidence threshold may be determined based on a center value of a predetermined value range, or may be determined based on an upgrade degree in branch prediction performance.

According to the embodiment of the present disclosure, in the case where the first branch prediction confidence meets the confidence condition, the access control unit 03 may prohibit a second branch prediction from being performed by the second branch prediction logic 02 on the current branch address; and in the case where the first branch prediction confidence does not meet the confidence condition, the access control unit 03 may control the second branch prediction logic 02 to perform a second branch prediction on the current branch address.

According to the embodiment of the present disclosure, in the case where the first branch prediction confidence meets the confidence condition, the access control unit 03 may prohibit the second branch prediction logic from updating a branch record corresponding to the current branch address. In the case where the first branch prediction confidence does not meet the confidence condition, the access control unit 03 may control the second branch prediction logic to update a branch record corresponding to the current branch address.

The branch prediction unit according to the embodiment of the present disclosure may further include a counter. The counter may be configured to, after executing a branch instruction corresponding to the current branch address, record an actual jump direction of the branch instruction corresponding to the current branch address. For example, in the case where the actual jump direction of the branch instruction indicates an instruction jump, the counter adds a first value to a count value, and in the case where the actual jump direction of the branch instruction indicates no instruction jump, the counter subtracts a first value from the count value. For example, the branch record may be represented by the count value, wherein the value of the highest bit of the count value indicates a trusted branch prediction direction of the current branch address, and the value of the remaining bits of the count value indicates the branch history of the current branch address.

Exemplarily, taking a bimodal predictor with 2 or 3 bits as an example, the bimodal predictor may use the highest bit as the branch prediction direction; for a target-based predictor (such as Branch Target Buffer, BTB), an extension bit may be added to indicate the branch prediction confidence of a hit target. In this case, the embodiment of the present disclosure may regard the highest bit as the branch prediction direction, and the remaining lower bits as the confidence degree of the branch prediction direction.

According to the embodiment of the present disclosure, the first branch prediction unit 01 may determine the trusted branch prediction direction indicated by the value of the highest bit of the count value as a first branch prediction direction indicated by the first branch prediction result. In addition, the first branch prediction unit 01 may further determine the first branch prediction confidence according to a matching degree between the branch history indicated by the value of the remaining bits of the count value and the first branch prediction direction.

According to the embodiment of the present disclosure, the access control unit 03 may be further configured to determine to perform the first branch prediction or the second branch prediction according to a historical branch prediction confidence and a confidence allocation limit. In the case where the historical branch prediction confidence is greater than or equal to the confidence allocation limit, the access control unit 03 may determine that the first branch prediction is to be performed by the first branch prediction logic. And, in the case where the historical branch prediction confidence is less than the confidence allocation limit, the access control unit 03 may determine that the second branch prediction is to be performed by the second branch prediction logic, wherein prediction accuracy of the second branch prediction is higher than that of the first branch prediction.

The process of performing branch prediction by the branch prediction unit as described above is similar to the branch prediction method described above in connection with FIG. 4, and details are not described herein again.

When adopting multi-stage branch prediction (e.g., having a first branch prediction logic 01 and a second branch prediction logic 02), using the branch prediction unit as shown in FIG. 6 can achieve a balance between prediction accuracy and power consumption of branch prediction, that is, reducing power consumption of the branch prediction as much as possible while ensuring prediction accuracy of the branch prediction.

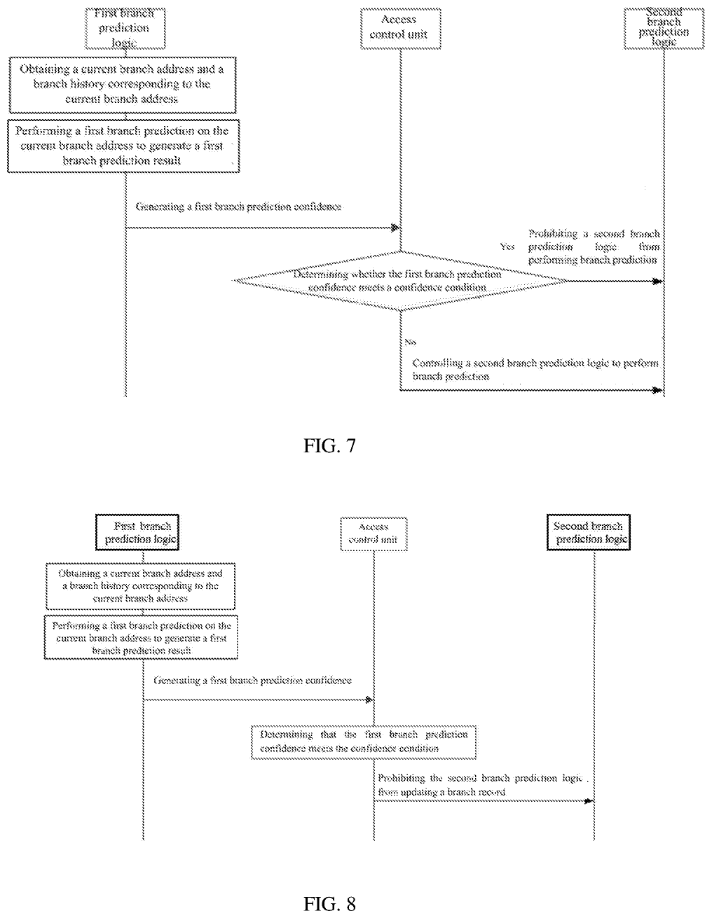

FIGS. 7 and 8 respectively show schematic views of implementation according to some embodiments of the present disclosure, and the process of performing branch prediction by a branch prediction unit according to the present disclosure will be described in detail below with reference to FIGS. 7 and 8.

As shown in FIG. 7, the first branch prediction logic 01 and the second branch prediction logic 02 may be any adjacent two stages of branch prediction logic in the branch prediction unit 101, and the stage number of the second branch prediction logic 02 is higher than that of the first branch prediction logic 01. By way of example, in conjunction with FIG. 3, the first branch prediction logic 01 shown may be the first-stage branch prediction logic 1011 in the branch prediction unit 101, and the second branch prediction logic 02 may be the second-stage branch prediction logic 1012 in the branch prediction unit 101. Obviously, the stage number of the first branch prediction logic 01 is not limited to the first-stage, for example, the first branch prediction logic may be the second-stage branch prediction logic, and the second branch prediction logic may be the third-stage branch prediction logic, as long as the first and second branch prediction logics are adjacent two stages of branch prediction logic in the branch prediction unit, and the stage number of the second branch prediction logic is higher than that of the first branch prediction logic.

As an optional implementation of the embodiment of the present disclosure, the adjacent two stages of branch prediction logic may correspond to one access control unit 03, and the access control unit 03 may be used to perform access control over the higher branch prediction logic (e.g., the second branch prediction logic) in the adjacent two stages of branch prediction logic corresponding thereto. The access control referred to in the embodiment of the present disclosure includes, but not limited to, branch prediction control and branch record update control. The branch prediction control may refer to controlling whether the second branch prediction logic performs the second branch prediction, and the branch record update control may refer to controlling whether the second branch prediction logic updates the branch record.

The branch record is a basis for the branch prediction logic to perform branch prediction, the branch record may record the historical execution information of the branch instruction and the historical branch result. Referring to FIG. 6, in the embodiment of the present disclosure, when performing branch prediction of the current branch address, input of the branch prediction unit may be the current branch address and the branch history corresponding to the current branch address. Exemplarily, the current branch address may be a next fetch start address of the last output from the branch prediction unit, and the corresponding branch history of the current branch address may indicate the corresponding historical branch direction of the current branch address. At this time, the branch history corresponding to the current branch address may be partial information of the branch record corresponding to the current branch address, for example, in the case where the branch record is represented by the count value as described above, the branch history may be indicated by the remaining bits other than the highest bit of the count value.

In the embodiment of the present disclosure, any branch prediction logic (e.g., the first branch prediction logic 01 and the second branch prediction logic 02) may perform branch prediction on the current branch address, and output a branch prediction result corresponding to the current branch address. According to the embodiment of the present disclosure, any branch prediction logic may also output a corresponding branch prediction confidence according to its outputted branch prediction result and a branch history corresponding to the current branch address. The branch prediction confidence can indicate prediction accuracy of the branch prediction result outputted by the branch prediction logic for the current branch address.

Optionally, in the embodiment of the present disclosure, the first branch prediction logic 01 may perform the first branch prediction on the current branch address. For example, the first branch prediction logic 01 may perform branch prediction on the current branch address according to the basis (i.e., branch record) for performing branch prediction, and output a first branch prediction result corresponding to the current branch address. The first branch prediction logic 01 may, in addition to outputting the first branch prediction result, output the first branch prediction confidence corresponding to the first branch prediction result according to the first branch prediction result and the branch history corresponding to the current branch address. The first branch prediction confidence may represent prediction accuracy of the first branch prediction result outputted by the first branch prediction logic 01.

Optionally, the instruction fetch unit may access the first branch prediction logic 01, and perform an instruction fetch operation according to the first branch prediction result generated by the first branch prediction logic 01. For example, the first branch prediction result may be fed to the instruction fetch unit 102, the instruction fetch unit 102 fetches the instruction according to the first branch prediction result. For example, the instruction fetch unit 102 may perform instruction fetching according to a fetch address of the branch instruction indicated by the first branch prediction result (including a fetch start address and a fetch end address of the branch instruction). At this time, since the stage number of the first branch prediction logic is relatively low, that is, the prediction accuracy is relatively low, the read instruction may be correct or may be incorrect.

The first branch prediction confidence outputted by the first branch prediction logic 01 may be fed to the access control unit 03 to perform the access control on the second branch prediction logic 02 by the access control unit 03, thereby determining, based on the first branch prediction confidence of the first branch prediction logic, whether to access the higher-stage second branch prediction logic 02, which achieves a balance between prediction accuracy and power consumption of the branch prediction, and provides the possibility of reducing power consumption of branch prediction while achieving higher prediction accuracy of branch prediction.

Further, as shown in FIG. 6, the current branch address and the corresponding branch history may also be fed back to the access control unit 03, and when the access control unit 03 determines to access the higher-stage second branch prediction logic 02, the access control unit 03 may feed the current branch address and corresponding branch history to the second branch prediction logic 02.

In the embodiment of the present disclosure, the access control performed by the access control unit 03 on the second branch prediction logic 02 may be classified into a branch prediction control and a branch record update control.

As an optional implementation of the contents disclosed in the embodiment of the present invention, when performing branch prediction control, the access control unit 03 may determine whether the first branch prediction confidence meets the predetermined confidence condition based on the first branch prediction confidence outputted by the first branch prediction logic.

If yes, it indicates that prediction accuracy of the first branch prediction result outputted by the first branch prediction logic 01 is relatively high, and the first branch prediction result may be used for subsequent pipeline operations without further accessing the second branch prediction logic 02, thus, the access control unit 03 may prohibit the second branch prediction logic 02 from performing the second branch prediction, which reduces power consumption of the branch prediction.

If not, it indicates that prediction accuracy of the first branch prediction result outputted by the first branch prediction logic 01 is relatively low, the first branch prediction result may have a relatively large error, and the second branch prediction logic 02 needs to perform the second branch prediction on the current branch address, so as to determine whether to re-fetch the instruction based on the second branch prediction result outputted by the second branch prediction logic 02, thereby ensuring that the branch prediction has relatively high prediction accuracy. For convenience of explanation, the branch prediction result outputted by the second branch prediction logic 02 for the current branch address is referred to as the second branch prediction result in the embodiment of the present disclosure.

Optionally, if there is further higher-stage branch prediction logic in the branch prediction unit that is higher than the second branch prediction logic, for example, a third branch prediction logic (not shown), the second branch prediction logic may be regarded as the first-stage branch prediction logic with respect to the third-stage branch prediction logic, the further higher-stage branch prediction logic may be regarded as the second-stage branch prediction logic, so that branch prediction control can be continued to perform on the further higher-stage branch prediction logic according to the foregoing flows. Likewise derivation may be made, the embodiment of the present disclosure can implement branch prediction control on the higher-stage branch prediction logic in the case where the branch prediction unit has multiple stages of branch prediction logic, and achieve the effect of balancing prediction accuracy and power consumption of the branch prediction.

According to another embodiment of the present disclosure, the second branch prediction result outputted by the second branch prediction unit may be compared with the first branch prediction result to determine whether to correct the instruction fetching performed based on the first branch prediction result.

Optionally, the instruction fetch unit may determine whether the second branch prediction result is consistent with the first branch prediction result. If the second branch prediction result is consistent with the first branch prediction result, the instruction fetching may not be corrected, if the second branch prediction result is inconsistent with the first branch prediction result, since prediction accuracy of the second branch prediction logic is higher than that of the first branch prediction logic, the instruction fetching may be corrected based on the second branch prediction result (e.g., the instruction fetching is corrected based on the fetch address indicated by the second branch prediction result).

Further, if the second branch prediction result is consistent with the first branch prediction result, it indicates that the currently-obtained branch prediction result already has high prediction accuracy, if the branch prediction unit further has other branch prediction logic having a higher stage number than the second branch prediction logic, the embodiment of the present disclosure may disable the other higher-stage branch prediction logic.

The embodiment of the present disclosure may determine whether to update the branch record of the second branch prediction logic based on whether the first branch prediction confidence meets a predetermined condition. It should be noted that, as an optional implementation, update of the branch record may be implemented after execution of the branch instruction (specifically, the execution unit of the processor core may implement execution of the branch instruction), after the branch instruction is executed, the actual jump direction of the branch instruction can be determined, thereby the branch record of the branch instruction is updated according to the actual jump direction of the branch instruction (i.e., updating the branch record corresponding to the branch address of the branch instruction).

FIG. 8 shows a schematic diagram of some embodiments of performing a branch record update according to some embodiments of the present disclosure. The process that the first branch prediction logic 01 obtains a current branch address and a branch history corresponding to the current branch address, performs a first branch prediction on the current branch address, generates a first branch prediction result, and generates a first branch prediction confidence according to the branch history and the first branch prediction is similar to the description provided above with respect to FIG. 7, and details are not repeated herein again.

As shown in FIG. 8, the access control unit 03 may prohibit the second branch prediction logic 02 from updating the branch record in the case where it is determined that the first branch prediction confidence meets a predetermined confidence condition. Specifically, after the branch instruction corresponding to the current branch address is executed, the second branch prediction logic is prohibited from updating the corresponding branch record. The access control unit 03 may control the second branch prediction logic 02 to update the branch record in the case where it is determined that the first branch prediction confidence does not satisfy the predetermined confidence condition. The update branch instruction may be performed after the branch instruction corresponding to the current branch address is executed. For example, when the first branch prediction confidence meets a predetermined confidence condition, it indicates that the first branch prediction logic already has relatively high prediction accuracy of the branch prediction for the current branch address, and there is a relatively low probability to subsequently use the second branch prediction logic for performing the second branch prediction on the current branch address, therefore, the access control unit 03 may prohibit updating the branch record of the second branch prediction logic so as to reduce power consumption of the branch prediction.

Further, the first branch prediction logic 01 may further update the branch record according to the execution result of the branch instruction, and specifically, after the branch instruction corresponding to the current branch address is executed, the branch record corresponding to the current branch address is updated based on the actual jump direction of the branch instruction.

Optionally, if there is a further higher-stage branch prediction logic in the branch prediction unit that is higher than the second branch prediction logic, branch prediction control and branch record update control may be performed on the further higher-stage branch prediction logic.

Optionally, although the foregoing description is provided by using adjacent two stages of branch prediction logic to correspond to one access control unit as an example, in the embodiment of the present disclosure, the multiple branch prediction logics in the branch prediction unit may also correspond to one access control unit.

In the branch prediction method provided by the embodiment of the present disclosure, the first branch prediction may be performed on the current branch address to generate the first branch prediction result, a first branch prediction confidence may be generated according to the branch history and the first branch prediction result corresponding to the current branch address. Thereby, access control may be performed according to the first branch prediction confidence, for example, controlling whether to perform higher-stage second branch prediction and whether to update the branch record of the second branch prediction. In this way, based on the first branch prediction confidence, it is determined whether to access the higher-level second branch prediction logic, a balance between prediction accuracy and power consumption of the branch prediction is achieved, which provides the possibility of reducing power consumption of branch prediction while achieving a relatively high prediction accuracy of branch prediction.

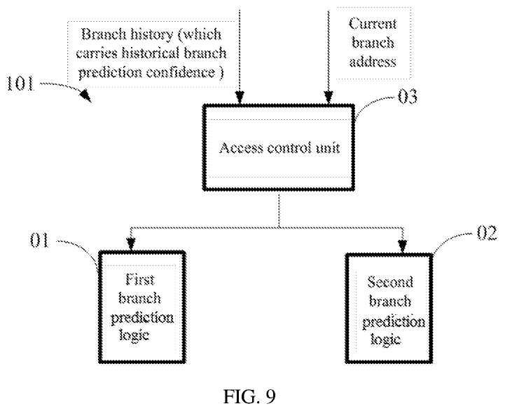

FIG. 9 shows a schematic block diagram of a branch prediction unit according to some embodiments of the present disclosure, wherein the access control unit 03 may allocate a branch prediction logic that is to perform branch prediction on the current branch address according to the historical branch prediction confidence for the branch address. In general, branch prediction of the branch address with lower historical branch prediction confidence is more difficult, this branch prediction may be performed by higher-stage branch prediction logic (e.g., the second branch prediction logic 02); and branch prediction of the branch address that has higher historical branch prediction confidence is less difficult, this branch prediction may be performed by lower-stage branch prediction logic (e.g., the first branch prediction logic 01).

In an optional implementation, the current branch address and the branch history corresponding to the current branch address may be inputted to the access control unit 03, and the branch history corresponding to the current branch address may further carry the historical branch prediction confidence for the current branch address by the first branch prediction logic. In one example, the branch history of the current branch address may record the branch prediction direction of the latest number of times of the current branch address and carries the historical branch prediction confidence for the current branch address by the first branch prediction logic.

The access control unit 03 may allocate a limit by the set confidence degree, and if the historical branch prediction confidence is lower than the set confidence allocation limit, the first branch prediction logic 01 is considered to have a relatively low prediction accuracy of the branch prediction for the current branch address, the branch prediction may be performed on the current branch address without using the first branch prediction logic 01, branch prediction on the current branch address is performed by the second branch prediction logic 02 instead.

If the historical branch prediction confidence is greater than or equal to the set confidence allocation limit, the first branch prediction logic 01 is considered to have relatively high prediction accuracy for the branch prediction of the current branch address, the first branch prediction logic 01 may be allocated to perform branch prediction on the current branch address.

Optionally, the historical branch prediction confidence for the current branch address by the first branch prediction logic 01 may be, for example, selected as the mean value of the prediction accuracy of the branch prediction after the branch prediction is executed based on historical results of the first branch prediction logic.

It should be noted that the logic, the unit referred to in the embodiment of the present disclosure may refer to a logic circuit unit in a processor core.

Many embodiments of the present disclosure are described above, and the various optional modes described in the embodiments may be combined and cross-referenced in the case of having no conflicts, thereby extending various possible embodiments. These may be considered as embodiments revealed and disclosed in the embodiments of the present disclosure.

The embodiment of the present disclosure also provides a processor core that can include a branch prediction unit as described above.

According to the branch prediction method, the branch prediction unit, and the processor core of the present disclosure, prediction accuracy and power consumption of the branch prediction can be balanced when using the multi-stage branch prediction logic, that is, power consumption of branch prediction is reduced as much as possible while ensuring prediction accuracy of the branch prediction.

As will be appreciated by those of ordinary skill in the art, all or parts of the steps in the above embodiments may be implemented by a program that instructs relevant hardware, the program may be stored in a computer-readable storage medium, such as a read-only memory, a magnetic disc, an optical disk, or the like. Optionally, all or parts of the steps of the above embodiments may also be implemented using one or more integrated circuits. Correspondingly, each module/unit in the foregoing embodiments may be implemented in form of hardware, or may be implemented in form of a software functional module. The present disclosure is not limited to any specific form of combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The above is illustration of the present disclosure and should not be construed as making limitation thereto. Although some exemplary embodiments of the present disclosure have been described, a person skilled in the art can easily understand that many modifications may be made to these exemplary embodiments without departing from the creative teaching and advantages of the present disclosure. Therefore, all such modifications are intended to be included within the scope of the present disclosure as defined by the appended claims. As will be appreciated, the above is to explain the present disclosure, it should not be constructed as limited to the specific embodiments disclosed, and modifications to the present disclosure and other embodiments are included in the scope of the attached claims. The present disclosure is defined by the claims and their equivalents.

1. A branch prediction method, comprising:
obtaining a current branch address and a branch history corresponding to the current branch address;
performing a first branch prediction on the current branch address to generate a first branch prediction result;
generating a first branch prediction confidence according to the branch history and the first branch prediction result; and
performing access control according to the first branch prediction confidence.

2. The method of claim 1, wherein performing access control according to the first branch prediction confidence comprises determining whether the first branch prediction confidence meets a confidence condition based on a confidence threshold, wherein
in the case where the first branch prediction confidence is greater than or equal to the confidence threshold, it is determined that the first branch prediction confidence meets the confidence condition;
in the case where the first branch prediction confidence is less than the confidence threshold, it is determined that the first branch prediction confidence does not meet the confidence condition.

3. The method of claim 2, wherein the confidence threshold is determined according to a central value of a predetermined value range, or the confidence threshold is determined according to an upgrade degree of branch prediction performance.

4. The method of claim 2, wherein performing access control according to the first branch prediction confidence further comprises:
in the case where the first branch prediction confidence meets the confidence condition, prohibiting a second branch prediction from being performed on the current branch address; and
in the case where the first branch prediction confidence does not meet the confidence condition, performing a second branch prediction on the current branch address.

5. The method of claim 4, wherein performing access control according to the first branch prediction confidence further comprises:
in the case where the first branch prediction confidence meets the confidence condition, prohibiting updating a branch record corresponding to the current branch address; and
in the case where the first branch prediction confidence does not meet the confidence condition, updating a branch record corresponding to the current branch address.

6. The method of claim 5, wherein updating a branch record corresponding to the current branch address comprises, after executing a branch instruction corresponding to the current branch address, updating a branch record corresponding to the current branch address.

7. The method of claim 6, further comprising, after executing a branch instruction corresponding to the current branch address, recording an actual jump direction of the branch instruction corresponding to the current branch address.

8. The method of claim 7, wherein recording an actual jump direction of the branch instruction corresponding to the current branch address comprises:
after executing the branch instruction corresponding to the current branch address, when the actual jump direction of the branch instruction indicates an instruction jump, adding a first value to a count value, and when the actual jump direction of the branch instruction indicates no instruction jump, subtracting a first value from the count value,
wherein the count value represents the branch record, the value of the highest bit of the count value indicates a trusted branch prediction direction of the current branch address, and the value of the remaining bits of the count value indicates the branch history of the current branch address.

9. The method of claim 8, wherein performing a first branch prediction on the current branch address to generate a first branch prediction result comprises:
determining the trusted branch prediction direction indicated by the value of the highest bit of the count value as a first branch prediction direction indicated by the first branch prediction result;
generating a first branch prediction confidence according to the branch history and the first branch prediction result comprises:
determining the first branch prediction confidence according to a matching degree between the branch history indicated by the value of the remaining bits of the count value and the first branch prediction direction.

10. The method of claim 3, wherein determining whether the first branch prediction confidence meets a confidence condition based on a confidence threshold further comprises:
in the case where the number of times for which the first branch prediction confidence meets the confidence condition reaches a times threshold, directly determining the first branch prediction confidence as meeting the confidence condition, and comparing the first branch prediction confidence and the confidence threshold at intervals.

11. The method of claim 9, further comprising:
determining to perform the first branch prediction or the second branch prediction according to a historical branch prediction confidence and a confidence allocation limit, wherein prediction accuracy of the second branch prediction is higher than that of the first branch prediction.

12. The method of claim 11, wherein
in the case where the historical branch prediction confidence is greater than or equal to the confidence allocation limit, it is determined to perform the first branch prediction; and
in the case where the historical branch prediction confidence is less than the confidence allocation limit, it is determined to perform the second branch prediction.

13. A branch prediction unit, comprising:
a first branch prediction logic configured to obtain a current branch address and a branch history corresponding to the current branch address, perform a first branch prediction on the current branch address to generate a first branch prediction result, and generate a first branch prediction confidence according to the branch history and the first branch prediction result;
an access control unit configured to perform access control according to the first branch prediction confidence; and
a second branch prediction logic configured to perform a second branch prediction according to access control of the access control unit.

14. The branch prediction unit of claim 13, the access control unit is further configured to determine whether the first branch prediction confidence meets a confidence condition based on a confidence threshold, which comprises: in the case where the first branch prediction confidence is greater than or equal to the confidence threshold, determining that the first branch prediction confidence meets the confidence condition; in the case where the first branch prediction confidence is less than the confidence threshold, determining that the first branch prediction confidence does not meet the confidence condition, wherein the confidence threshold is determined according to a central value of a predetermined value range, or the confidence threshold is determined according to an upgrade degree of branch prediction performance.

15. The branch prediction unit according to claim 14, wherein in the case where the first branch prediction confidence meets the confidence condition, the access control unit prohibits a second branch prediction from being performed by the second branch prediction logic on the current branch address; and in the case where the first branch prediction confidence does not meet the confidence condition, the access control unit controls the second branch prediction logic to perform a second branch prediction on the current branch address.

16. The branch prediction unit of claim 15, wherein in the case where the first branch prediction confidence meets the confidence condition, the access control unit prohibits the second branch prediction logic from updating a branch record corresponding to the current branch address; and in the case where the first branch prediction confidence does not meet the confidence condition, the second branch prediction logic controls the second branch prediction logic to update a branch record corresponding to the current branch address.

17. The branch prediction unit of claim 16, further comprising: a counter configured to, after executing a branch instruction corresponding to the current branch address, record an actual jump direction of the branch instruction corresponding to the current branch address, wherein in the case where the actual jump direction of the branch instruction indicates an instruction jump, the counter adds a first value to a count value, and in the case where the actual jump direction of the branch instruction indicates no instruction jump, the counter subtracts a first value from the count value,
wherein the count value represents the branch record, the value of the highest bit of the count value indicates a trusted branch prediction direction of the current branch address, and the value of the remaining bits of the count value indicates the branch history of the current branch address.

18. The branch prediction unit of claim 17, wherein the first branch prediction unit determines the trusted branch prediction direction indicated by the value of the highest bit of the count value as a first branch prediction direction indicated by the first branch prediction result; and
the first branch prediction unit determines the first branch prediction confidence according to a matching degree between the branch history indicated by the value of the remaining bits of the count value and the first branch prediction direction.

19. The branch prediction unit according to claim 18, wherein the access control unit is further configured to: determine to perform the first branch prediction or the second branch prediction according to a historical branch prediction confidence and a confidence allocation limit, wherein
in the case where the historical branch prediction confidence is greater than or equal to the confidence allocation limit, the access control unit determines to perform the first branch prediction by the first branch prediction logic; and
in the case where the historical branch prediction confidence is less than the confidence allocation limit, the access control unit determines to perform the second branch prediction by the second branch prediction logic, wherein prediction accuracy of the second branch prediction is higher than that of the first branch prediction logic.

20. A processor core, comprising the branch prediction unit of claim 13.
